(19) United States
(12) Patent Application Publication
(10) Pub. No.: US 2005/0093714 A1
(43) Pub. Date: May 5, 2005

(54) Segment display device

(75) Inventor: Anton Kolar, Villingen-Schwenningen (DE)

Correspondence Address: SIEMENS SCHWEIZ;I-44, INTELLECTUAL PROPERTY, ALBISRIEDERSTRASSE 245, ZURICH, CH-8047, CH

(73) Assignee: SIEMENS AKTIENGESELLSCHAFT, Munich (DE)

(21) Appl. No.: 11/001,058

(22) Filed: Dec. 2, 2004

Related U.S. Application Data
(63) Continuation of application No. PCT/DE03/01724, filed on May 27, 2003.

(30) Foreign Application Priority Data
Jun. 12, 2002 (DE) 102 26 083.4

(51) Int. Cl. G08B 5/00

(52) U.S. Cl. 340/815.4; 340/438

(57) ABSTRACT

The invention relates to a segment display device that comprises a plurality of illuminable display segments (3) disposed in series (2) and that is provided for displaying a system status of a system to be monitored. The status is displayed by means of a number of illuminated display segments (3) corresponding to the system status to be displayed or to a pattern of said segments corresponding to the system status to be displayed. Optionally at least two different kinds of system statuses can be displayed. The respective mode of operation thereof is selected by different fitting positions in an instrument panel or by different preset configurations of the drive interfaces that are permanently assigned to the various types of system statuses.

The invention relates to a segment display device, in particular for application in motor vehicle dashboards.

In motor vehicles, the tank filling level display and the cooling water temperature display, for example, are still mostly designed as scaled pointer instruments. Occasionally, these displays are designed as bar code displays. In the case of a tank filling level display, for example, bars of a bar code that are located behind a dial are controlled here in accordance with the filling level in the vehicle tank. An associated symbol and a scale are printed on the associated dial.

The object of the present invention consists, in particular, in making available a display device with the aid of which the technical outlay for producing dashboards, in particular motor vehicle dashboards, is reduced.

This object is achieved by means of a segment display device having the features of patent claim 1. Features of advantageous developments and embodiments of the segment display device are specified in the subclaims 2 to 7.

The segment display device in accordance with the invention has a number of illuminable display segments arranged in a serial fashion, for example in a linear row or a row arranged arcuately. The display of a current value of a system status of a system to be monitored is performed by means of a number of illuminable display segments corresponding to this value, or by means of a pattern of illuminable display segments corresponding to this value. According to the invention, one and the same series of display segments can optionally be driven by mutually different and independent drive devices with the aid of signals that relate to values of mutually different system statuses.

The respectively desired operating mode of the segment display device is advantageously set solely by selecting the installed position of the segment display device in the dashboard when the latter is being assembled.

If the segment display device is provided in a motor vehicle for the purpose of displaying two different system statuses such as tank filling level and cooling water temperature, for example, the segment display device therefore has two different installed positions in the dashboard at which the display elements are driven differently.

By way of example, the segment display device displays the tank filling level in a first installed position and, with the aid of one and the same series of display elements, displays the engine cooling water temperature in a second installed position, which is, for example, rotated by 180° in relation to the first installed position.

In order to display the respective operating mode, the segment display device in this case preferably has two different illuminable symbols, for example a filling pump and a thermometer, of which, likewise as a function of the installed position of the segment display device only the one respectively belonging to the displayed system status is driven and illuminated.

The segment display device preferably has a separate drive interface for each of its various operating modes. The drive interface is preferably selected by selection of the installed position of the segment display device in an associated instrument holder of a dashboard.

Alternatively, the segment display device has a single drive interface with different connection configurations assigned to the various operating modes, and the connection configuration provided for the selected operating mode is preferably selected, in turn, by the selection of the installed position of the segment display device in an associated instrument holder of a dashboard.

The segment display device is preferably optionally provided for displaying system statuses that are determined by different measuring devices in the system to be monitored.

It is preferred that a display symbol that displays the associated operating mode is respectively provided for each of the various operating modes.

The segment display device is provided with particular preference for installation in a motor vehicle dashboard and in a first installed position in the dashboard displays the contents of the tank, for example, and in a second installed position in the dashboard displays the engine cooling water temperature.

If the operating mode is selected solely by selection from different installed positions, the segment display device can thus be designed for different uses as a so-called identical part. This means that one and the same display device can optionally be used for various system status displays. It is thereby possible to save substantial costs by comparison with conventional solutions.

The desired operating mode of the segment display device can, however, be selected solely via the drive interface; that is to say the drive interface preferably has at least two different connection configurations, of which one is assigned to a first operating mode, and one to a second operating mode. The switchover and display (for example by means of different symbols) from one operating mode (for example display of the filling level of a first brake circuit) to the other operating mode (for example display of the filling level of a second brake circuit) and vice versa can be performed manually with the aid of a switch, or automatically at specific time intervals.

The segment display device is preferably backlit in two colors. It is then advantageously possible to switch over the color of the segment display device from, for example, yellow to red in the case of a warning (for example when the reserve is reached in the fuel tank, or upon overshooting of an upper limit of the engine cooling water temperature).

In addition to the illuminable display elements for the system status, the segment display device can have a scale that is constructed by means of one or more illuminable display segments provided for this purpose.

Such so-called multiple displays can be used to save space on instrument panels, for example of a dashboard.

The segment display device can be arranged in a display instrument, advantageously in a region without a dial.

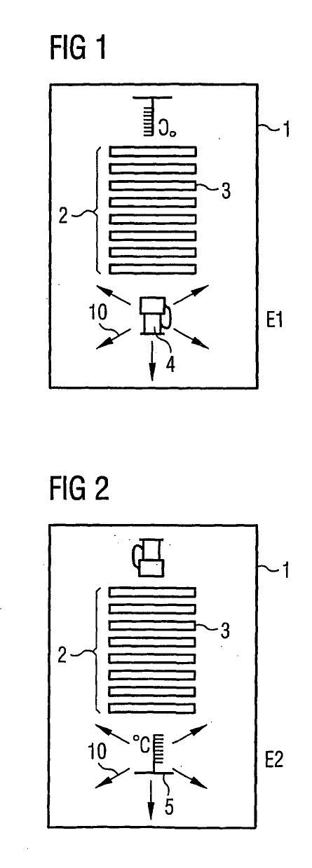

Further advantages and expediencies of the invention emerge from the two exemplary embodiments explained in more detail below in conjunction with FIGS. 1 to 3, in which:

FIG. 1 shows a schematic of a segment display device, having two possible operating modes, in the first operating mode;

FIG. 2 shows a schematic of the segment display device of FIG. 1, in the second operating mode;

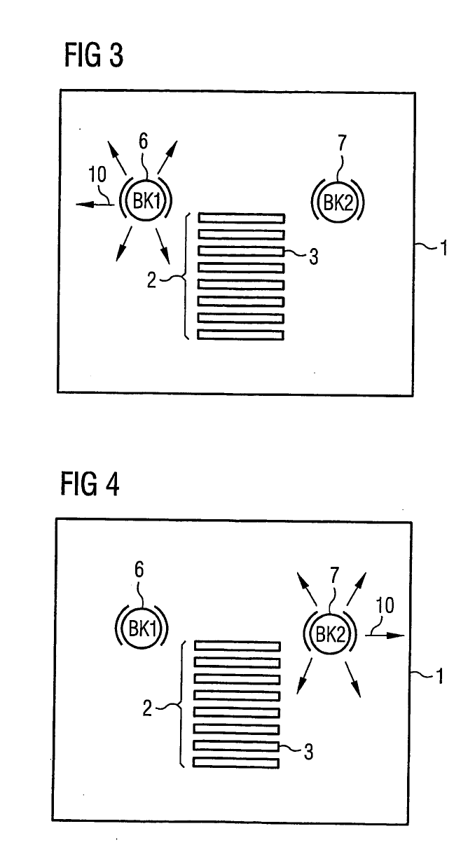

FIG. 3 shows a schematic of a segment display device that is designed as a multiple display and has two possible operating modes, in the first operating mode; and

FIG. 4 shows a schematic of the segment display device of FIG. 3, in the second operating mode.

In accordance with the exemplary embodiment of FIGS. 1 and 2, the segment display device is a display device for installation in a motor vehicle dashboard, and has in a display field 1 a single segment display 2 with a number of illuminable display segments 3 arranged in a row one above another. The optical illustration of a current value of a system status to be displayed such as, for example, fuel filling level in the fuel tank or engine cooling water temperature, is performed by means of a number, corresponding to this value, of illuminable display segments.

The exemplary embodiment has two different installed positions E1 (FIG. 1) and E2 (FIG. 2) that are rotated by 180° in relation to one another in the plane of the dashboard.

In the first installed position E1 (FIG. 1), the segment display device is, for example, in the operating mode of “tank filling level”. Apart from the segment display, there is also illuminated in this operating mode a filling tank symbol 4 (indicated by the arrows 10 around the symbol 4) that displays the operating mode of “tank filling level” of the segment display device.

In the second installed position E2 (FIG. 2), rotated by 180° in the plane of the dashboard in relation to the first installed position E1, the segment display device is, for example, in the operating mode of “engine cooling water temperature”. In addition to the segment display, there is also illuminated in this operating mode a thermometer symbol 5 (indicated by the arrows 10 around the symbol 5), that displays the operating mode of “engine cooling water temperature” of the segment display device.

In the exemplary embodiment, one and the same segment display 2 is driven as a function of the respective installed position with the aid of signals that relate to values of mutually different system statuses (tank filling level and engine cooling water temperature).

The segment display device is optionally provided for displaying system statuses that are determined by different measuring devices (filling level sensor and temperature sensor) in the system to be monitored.

The exemplary embodiment has a separate drive interface for each of the two operating modes. The drive interface used is selected by the selection of the installed position E1, E2 of the segment display device in the associated instrument holder of the dashboard.

Alternatively, the segment display device has a single drive interface with different connection configurations assigned to the various operating modes. In this case, the connection configuration provided for a selected operating mode is selected, in turn, by the selection of the installed position E1, E2 of the segment display device in the associated instrument holder of the dashboard.

In accordance with the exemplary embodiment, the segment display device is advantageously designed as an identical part for different uses. That is to say that one and the same display device is optionally used for various system status displays.

However, as in the case of the exemplary embodiment in accordance with FIGS. 3 and 4, the desired operating mode of the segment display device can be selected solely via the drive interface. That is to say, the drive interface has at least two different connection configurations, of which one is assigned to a first operating mode (for example display of the filling level of a first brake circuit), and one to a second operating mode (for example display of the filling level of a second brake circuit). Switching over from the first brake circuit BK1 (FIG. 1) to the second brake circuit BK2 (FIG. 2) and vice versa can be performed manually with the aid of a switch or automatically at specific prescribed time intervals. The respectively set brake circuit BK1, BK2 is displayed by means of corresponding illuminated brake circuit symbols 6, 7 (indicated by the arrows 10 around the respectively illuminated symbol).

The segment display devices of both exemplary embodiments are preferably backlit in two colors. It is then possible to switch over the color of the segment display device, from, for example, yellow to red in the case of a warning (for example when the reserve is reached in the fuel tank or in the brake circuits, or upon overshooting of an upper limit of the engine cooling water temperature).

In addition to the segment displays and the symbols, in accordance with the exemplary embodiments the segment display devices can respectively have a scale that can be implemented by means of one or more illuminable display segments provided additionally for this purpose.

1. A segment display device comprising: a plurality of illuminable display segments arranged in a series and provided for displaying a system status of a system to be monitored, and the display is performed by means of a number of illuminated display segments corresponding to this system status, or by means of a pattern of illuminated display segments corresponding to this system status, in which at least two mutually different types of system statuses can optionally be displayed, and characterized in that the display device can be used in different installed positions in a dashboard, and in that the operating mode is fixed in accordance with the installed position in the dashboard.

2. The segment display device according to claim 1, further comprising a separate drive interface for each of the various operating modes.

3. The segment display device according to claim 1, further comprising a drive interface with different connection configurations assigned to the various operating modes.

4. The segment display device according to claim 1, further comprising means for displaying system statuses that are determined by different measuring devices in the system to be monitored.

5. The segment display device according to claim 1, further comprising an illuminable display symbol that displays the associated operating mode is respectively provided for each of the various operating modes.

6. The segment display device according to claim 1, further comprising means for installation in a motor vehicle dashboard, and which in a first installed position in the dashboard displays the contents of the tank, and in a second installed position in the dashboard displays the engine cooling water temperature.

7. The segment display device according to claim 2, wherein the drive interfaces are designed in such a way that the different operating modes are set by means of installed positions rotated by predetermined angles in relation to one another.

8. The segment display device according to claim 2, further comprising means for displaying system statuses that are determined by different measuring devices in the system to be monitored.

9. The segment display device according to claim 3, further comprising means for displaying system statuses that are determined by different measuring devices in the system to be monitored.

10. The segment display device according to claim 2, further comprising an illuminable display symbol that displays the associated operating mode is respectively provided for each of the various operating modes.

11. The segment display device according to claim 3, further comprising an illuminable display symbol that displays the associated operating mode is respectively provided for each of the various operating modes.

12. The segment display device according to claim 4, further comprising an illuminable display symbol that displays the associated operating mode is respectively provided for each of the various operating modes.

13. The segment display device according to claim 2, further comprising means for installation in a motor vehicle dashboard, and which in a first installed position in the dashboard displays the contents of the tank, and in a second installed position in the dashboard displays the engine cooling water temperature.

14. The segment display device according to claim 3, further comprising means for installation in a motor vehicle dashboard, and which in a first installed position in the dashboard displays the contents of the tank, and in a second installed position in the dashboard displays the engine cooling water temperature.

15. The segment display device according to claim 4, further comprising means for installation in a motor vehicle dashboard, and which in a first installed position in the dashboard displays the contents of the tank, and in a second installed position in the dashboard displays the engine cooling water temperature.

16. The segment display device according to claim 5, further comprising means for installation in a motor vehicle dashboard, and which in a first installed position in the dashboard displays the contents of the tank, and in a second installed position in the dashboard displays the engine cooling water temperature.

17. The segment display device according to claim 3, wherein the drive interfaces are designed in such a way that the different operating modes are set by means of installed positions rotated by predetermined angles in relation to one another.
